(19) United States
(12) Patent Application Publication
(10) Pub. No.: US 2012/0078035 A1
(43) Pub. Date: Mar. 29, 2012

(54) COVER FOR A BONE FIXTURE

(76) Inventors: Marcus Andersson, Goteborg (SE); Goran Bjorn, Onsala (SE)

(21) Appl. No.: 12/891,478

(22) Filed: Sep. 27, 2010

(51) Int. Cl. H04R 25/00

(52) U.S. Cl. 600/25

(57) ABSTRACT

A cover for a bone fixture, including a recess to receive an abutment, implanted into a skull of a recipient, the bone fixture being a part of a bone conduction hearing prosthesis. The cover includes a fixation device sized and dimensioned to rigidly connect the cover to the implanted bone fixture, and a ferromagnetic material reactive to a magnetic field, wherein the cover is dimensioned to cover at least the recess of the bone fixture, and wherein the fixation device is configured to transmit vibrations induced in the cover via the magnetic field into the implanted bone fixture.

### BACKGROUND

1. Field of the Invention

The present invention relates generally to a bone conduction implant, and more particularly, to a cover for a bone fixture used to induce vibrations into the bone fixture.

2. Related Art

For persons who cannot benefit from traditional acoustic hearing aids, there are other types of commercially available hearing prostheses such as, for example, bone conduction hearing prostheses (also referred to as “bone conduction hearing aids,” “bone conduction devices,” and “bone anchored hearing aids”). Bone conduction devices mechanically transmit sound information to a person's inner ear by transferring vibrations to a person's skull. This enables the hearing prosthesis to be effective regardless of whether there is disease or damage in the middle ear.

Traditionally, bone conduction devices transfer vibrations from an external vibrator to the skull through a bone fixture that is physically attached to or implanted in the skull. Typically, the external vibrator is connected to a percutaneous abutment which is attached to the bone fixture located behind the external ear so that sound is transmitted via the skull to the cochlea. One example of this type of hearing device is described in U.S. Pat. No. 4,498,461.

Generally, the percutaneous bone conduction implant connecting the external vibrator (the portion containing the device that generates the vibrations that are transmitted to the person's skull) to the skull comprises two components: a bone attachment piece, herein referred to as a bone fixture, that is attached or implanted directly into the skull, and a skin penetrating piece attached to the bone attachment piece (often referred to as an abutment). The external vibrator typically can easily be connected to the abutment by a bayonet coupling, a snap-in coupling, magnetic coupling, etc.

### SUMMARY

In accordance with one aspect of the present invention, there is a cover for a bone fixture, including a recess to receive an abutment, the cover comprising a fixation device sized and dimensioned to rigidly connect the cover to the bone fixture and a ferromagnetic material reactive to a magnetic field, wherein the cover is dimensioned to cover at least the recess of the bone fixture, and wherein the fixation device is configured to transmit vibrations induced in the cover via the magnetic field into the bone fixture.

In accordance with another aspect of the present invention, there is a method of monitoring an osseointegration progress, the method comprising inducing vibration of a ferromagnetic material of a cap connected to an the implanted bone fixture via a transcutaneous magnetic field, and identifying a vibrational characteristic of the implanted bone fixture.

In accordance with another aspect of the present invention, there is a method of enhancing osseointegration of an implanted bone fixture, the method comprising transcutaneously inducing a low frequency vibration of the implanted bone fixture.

### BRIEF DESCRIPTION OF THE DRAWINGS

Embodiments of the present invention are described in the following detailed description when taken with reference to the accompanying drawings, in which:

FIG. 1A is a cross-sectional view of an exemplary bone conduction device with which an embodiment of the present invention may be used;

FIG. 1B is a cross-sectional view of an exemplary bone conduction implant with which an embodiment of the present invention may be used;

FIG. 1C is a perspective view of an exemplary bone conduction device prior to attachment of the external vibrator to the bone conduction implant with which an embodiment of the present invention may be used;

FIG. 2 is a cross-sectional view of an exemplary cover screw inserted into a bone fixture;

FIG. 3 is a side view of an exemplary cover according to an exemplary embodiment of the invention;

FIG. 4 is a cross-sectional view of another exemplary cover according to an exemplary embodiment of the invention;

FIG. 5 is a cross-sectional view of another exemplary cover according to an exemplary embodiment of the invention;

FIG. 6 is a functional schematic depicting an implant stability diagnostic monitor according to an exemplary embodiment of the present invention;

FIG. 7 is a flowchart representing a method of diagnosing progress of osseointegration according to an embodiment of the present invention;

FIG. 8 is a functional schematic depicting an osseointegration enhancement device according to an exemplary embodiment of the present invention;

FIG. 9 is a flowchart representing a method of enhancing osseointegration according to an embodiment of the present invention; and

FIG. 10 is a flowchart representing a method of determining the progress of osseointegration and enhancing osseointegration according to an embodiment of the present invention.

### DETAILED DESCRIPTION

Aspects of the present invention are, in part, generally directed to a cover, which may be in the form of a cover screw, configured to be attached to a bone fixture implanted into a skull of a recipient, where the bone fixture is part of a bone conduction implant configured to transmit vibrations indicative of sound from an external vibrator to the skull of the recipient to enhance hearing. The cover includes a fixation device sized and dimensioned to rigidly connect the cover to the implanted bone fixture. This fixation device may include, in the case of a cover screw, male threads that interface with female threads in a recess of the implanted bone fixture. When fixed to the implanted bone fixture, the cover prevents overgrowth of the female threads in the implanted bone fixture by bone tissue after implantation of the bone fixture into the skull of the recipient.

The cover further includes a ferromagnetic material, which may be in the form of a permanent magnet, reactive to a magnetic field. This magnetic field extends transcutaneoulsy and encompasses at least part of the ferromagnetic material. The magnetic field is used to induce a vibration in the cover through the skin of a recipient. The vibration may be a low-frequency vibration. In an exemplary embodiment, the fixation device is configured to transmit the vibrations induced in the cover via the magnetic field into the implanted bone fixture.

According to this exemplary embodiment, the cover may be used in a method of monitoring the progress of healing (the progress of osseointegration) of the skull after the bone fixture is implanted in the skull. This method may include recording and evaluating vibrational characteristic of the cover, such as, for example, the resonant frequency of the cover while the cover is attached to the bone fixture. Still further according to this exemplary embodiment, the cover may be used in a method of enhancing osseointegration of the bone fixture implanted in the skull of the recipient. Specifically, low frequency vibrations applied to the ferromagnetic material may be used to induce vibration in the implanted bone fixture to enhance osseointegration of the implanted bone fixture with the skull relative to osseointegration of the implanted bone fixture with the skull in the absence of the induced low frequency vibrations.

An embodiment of the cover according to an embodiment of the present invention is connectable to a bone fixture, such as a bone fixture that is configured to permit an abutment to be attached to a bone fixture, as will now be described.

In an exemplary embodiment, the cover may be used with a bone fixture that is part of a two piece bone conduction implant. One piece comprises a titanium bone fixture (also referred to herein as an implant bone fixture, and/or simply as a bone fixture or an implant) in the form of a screw, and the other piece comprises an abutment (also referred to herein as an abutment sleeve) that extends percutaneously from the bone fixture. Due to this two-part configuration of the bone conduction implant, the bone conduction implant may be up-graded, if desired, without removing the bone fixture from the skull. Further, if the abutment sleeve is damaged, the abutment may also be replaced without removing the bone fixture.

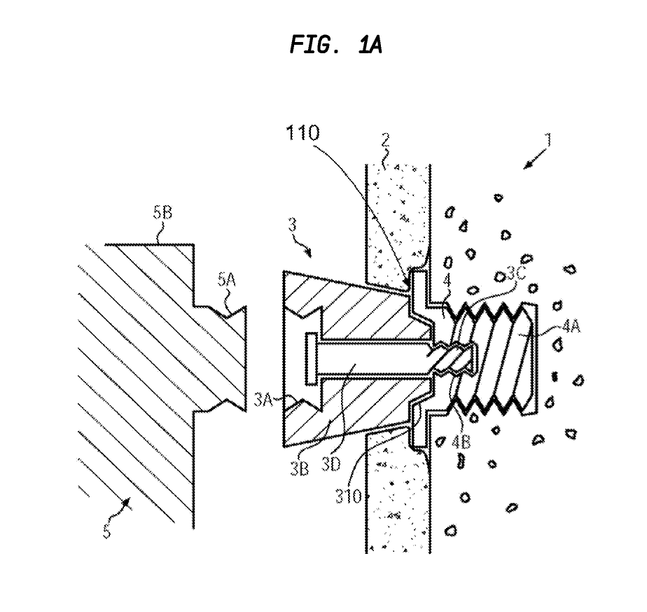

FIGS. 1A, 1B and 1C illustrate features of a bone conduction device with which the cap of the present invention may be utilized.

FIG. 1A provides a schematic illustration of a two-part bone conduction implant 110 with which the cap may be utilized. In FIG. 1A, reference numeral 1 denotes a skull of a recipient, reference numeral 2 denotes the skin of a recipient, reference numeral 3 denotes the abutment sleeve for skin penetration, reference numeral 4 denotes the bone fixture, and reference numeral 5 denotes an external vibrator that includes a vibrator that transmits vibrations to the bone conduction implant 110. The bone fixture 4 includes outer threads 4A and an inner threads 4B. The screw-shaped titanium bone fixture 4 depicted in FIG. 1A is fixed in a bore in the skull 1 by the outer threads 4A. The inner threads 4B of the bone fixture 4 are formed in a bore extending from an end portion of the bone fixture 4 facing the skin 2 in an axial direction of the bone fixture 4 toward an opposing end portion of the bone fixture 4.

Attached to the bone fixture 4 is an abutment sleeve 3, which comprises a screw 3D with a screw shaped end portion 3C that fits to the screw 3D of the bone fixture 4, a body 3B that penetrates the skin 2, and a coupling part 3A to which an external vibrator 5 can be coupled via a corresponding coupling part 5A. In FIG. 1A, the coupling part 3A of the abutment sleeve 3 and the corresponding coupling part 5A of the external vibrator 5 are formed as a snap-in connector. The cross-sections of the coupling part 3A and the corresponding coupling part 5A include a double cone shape, whereby the coupling part 3A is formed as a recess and serves as the female part of the snap in coupling, and the corresponding coupling part 5A is formed as a protrusion and serves as the male part of the snap in coupling which fits into the female part. According to this configuration, coupling part 3A and corresponding coupling part 5A form a snap in or a clip connection.

The screw 3D extends through the body 3B of the abutment sleeve 3 in an axial direction thereof so that the abutment sleeve 3 is fixed to the bone fixture 4. In some exemplary embodiments, the bone conduction implant 110 is provided with a rotation lock system that prevents or otherwise limits the abutment sleeve 3 from being rotated relative to the bone fixture 4. This is indicated in FIG. 1 A by reference numeral 310. Specifically, reference numeral 310 designates an exemplary external hex structure provided on a protrusion of the body 3B of the skin penetrating abutment sleeve 3, which fits to a corresponding internal hex-structure of the bone fixture 4.

In the embodiment depicted in the FIGs., the external vibrator 5 also includes a housing 5B that contains a microphone, signal and driving electronics and a vibrating mechanism so that the transmitter can transmit vibrations to the skull 1 through the skin 2.

FIG. 1B depicts a bone conduction implant 33 according to an alternate exemplary embodiment. As may be seen in FIG. 1B, there is an abutment sleeve 300A that penetrates the skin of the recipient, attached to a bone fixture 44 by a screw 300B. As is the case with the bone conduction implant 110 of FIG. 1A above, the bone conduction implant 33 of FIG. 1B is provided with a rotation lock system that prevents the abutment sleeve 300A from being rotated relative to the bone fixture 44. This is indicated in FIG. 1B by reference numeral 310. Reference numeral 310 designates an external hex structure provided on a protrusion of the bone fixture 44, which fits to a corresponding internal hex-structure of the abutment sleeve 300A.

It is noted at this time that other embodiments may use other structures, such as, for example, a square structure, etc., to prevent or otherwise limit rotation.

FIG. 1C depicts an isometric view of a bone conduction system 400 just prior to or just after attachment or detachment, respectively, of the external vibrator 5 via the coupling part 5A, to the abutment sleeve 3, which is attached to the bone fixture 4. As may be seen, the coupling part 5A provides a clip connection with the abutment sleeve. The coupling part 5A extends away from the housing 5B of the external vibrator 5, and the housing 5B may contain a microphone, signal and driving electronics and a vibrating mechanism, etc.

Bone conduction devices with which embodiments of the cap of the present invention may be utilized may include a bone conduction implant that is installed in a single stage procedure or a two stage procedure. In the case of the two stage procedure, referring to FIG. 1A by way of example, the bone fixture 4 is inserted in the skull during the first step. The bone fixture is subsequently maintained unloaded during a healing phase that may last up to several months after insertion of the bone fixture 4.

After this healing phase, the second step is performed. The second step includes the connection of the abutment sleeve 3 to the bone fixture. In the exemplary embodiment of FIG. 1A, a screw 3D is screwed into inner threads 4B, thereby securing the abutment sleeve 3 to the bone fixture 4.

During the healing phase, where the bone fixture 4 is integrating into the bone structure of the recipient, a cover, which in the embodiment of the bone conduction implant 110 depicted in FIG. 1 A may correspond to a cover screw because of the inner threads 4B in the bone fixture 4, is placed on top of the bone fixture 4. The cover limits and/or prevents bony over-growth of the inner threads 4B of the bone fixture 4.

In an exemplary embodiment, the bone fixture 4 and the cover screw are completely covered by skin, and a period of time is allowed to pass in order to allow the skull to heal and/or, with respect to children, not to interrupt bone growth .

At the second surgical stage, the cover screw is removed and an abutment is connected to the bone fixture, onto which abutment the external vibrator is subsequently placed.

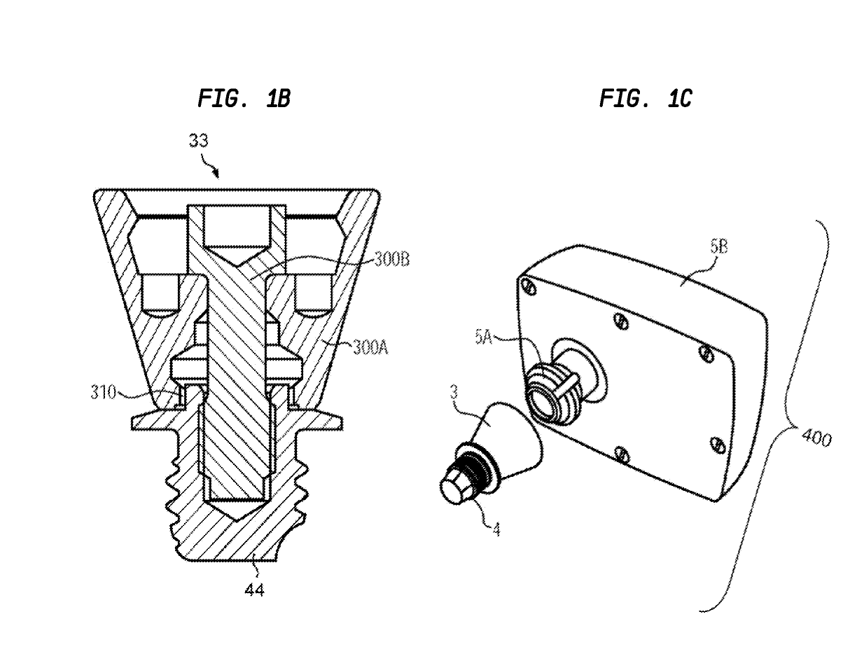

In an exemplary embodiment, the cover screw is in place during the entire, and the cover screw may function essentially as a cap or plug for protection of the inner threads 4B of the bone fixture 4. In case of implants for children, there might arise the problem that due to the high growth rate of the skull, it might be difficult to determine the exact position of the implant after the healing phase. FIG. 2 schematically illustrates, in an exemplary manner, usage of the cover screw during a healing phase. In FIG. 2, those features that are identical with features in FIG. 1 are designated with the same reference numerals. In FIG. 2 reference numeral 6 denotes the cover screw that includes a cap 6A, a handling portion 6B to facilitate inserting and removing the cover screw 6, and a threaded protrusion 6C that fits with the inner threads 4B of the bone fixture 4. During the healing phase, the cover screw 6 is completely covered by the skin 2 so that the healing process is improved whereby the cover screw protects the inner threads 4B of the titanium bone fixture 4.

It is noted that the two stage procedure (as opposed to simply attaching the abutment 3 to the bone fixture 4 during the same surgical procedure, shortly after the bone fixture 3 is installed in the skull of the recipient) is usually executed when there is a need for a longer time period for healing after the insertion of the bone fixture 4 in the skull before an external vibrator may be attached to an abutment 3 and safely used. In particular, the two stage procedure may be utilized with recipients with low bone quality and with children. The skulls of children are much thinner and softer compared to skulls of adults, and, therefore, it is prudent to provide more time to form a stable connection between the skull and the bone fixture 4. On the other hand, the skull of a child has a high growth rate, so that there exists the risk that the bone fixture 4 is overgrown by the bone. Hence, the utility of the cover screw according to an embodiment of the present invention.

In an exemplary embodiment, the time period for healing after the insertion of the bone fixture 4 into the skull is judged by the surgeons according to their own experience. In an exemplary embodiment, a waiting time until loading the bone fixture 4 with an abutment and connecting an external vibrator to the abutment is 6 months. However, in some embodiments, the waiting time may be 12 months until the second stage of the surgery is performed. This time period could be critical for a child who is about to develop speech. On the other hand, if the time is cut too short, and an adequate healing probess has not taken place, the implant might be unusable.

An embodiment of the present invention permits the shortening of this healing time, which may permit a relative increase in the progress of learning speech in deaf children relative to the unshortened healing time. An embodiment of the present invention permits improved accuracy in determining the healing time/determining the healing time more precisely in order to allow earlier use of the implanted bone fixture 4 and/or the acceleration of the healing time, as will now be more thoroughly described.

In more detail, the present invention provides a diagnostic tool that can determine if the implanted bone fixture 4 is stable enough for use with the external vibrator (hereinafter, “loading”). In an exemplary embodiment, the use of this diagnostic tool permits earlier loading, relative to not using the tool, and/or may permit a child to hear better earlier and develop speech earlier. Also, in an exemplary embodiment, the present invention provides for safer implantation procedures. In this regard, the bone fixture would only be loaded when it is properly anchored to the skull, an embodiment of the present invention permitting determination of this proper anchoring. This minimizes the risk of early implant loss.

An embodiment of the present invention may be used with at least some of the procedures detailed in U.S. Patent Application Publication No. 2007/0270684. An embodiment of the present invention may be used with the diagnostic tool detailed in U.S. Patent Application Publication No. 2007/0270684. This document discloses a tool for measuring implant stability and osseointegration. An embodiment utilizes Resonance Frequency Analysis (RFA) technology which is developed and sold by Osstell AB, wherein osseointegration is assessed by analyzing the resonant frequency of the implant. Also, embodiments of the present invention may be used with more advanced diagnostic tools than those described in U.S. Patent Application Publication No. 2007/0270684, which may be referred to as second generation Osstell Instruments, which do not require a fixed connection between the measurement device and the implant.

An embodiment of the present invention overcomes the potential drawback of having a long healing period. Specifically, an exemplary embodiment speeds up osseointegration of the skull with the bone fixture. In an exemplary embodiment, low frequency vibrations may be applied to the bone fixture via the cover screw to speed up the osseointegration process.

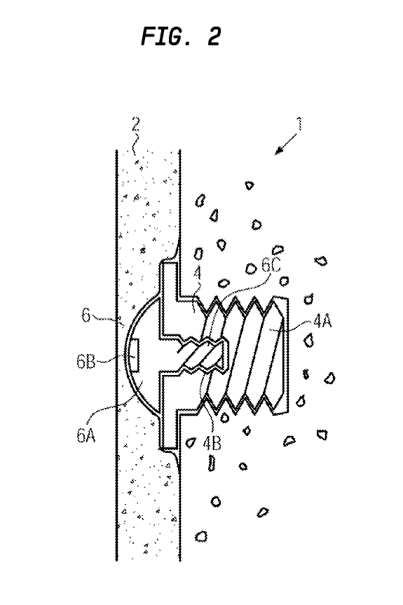

FIGS. 3, 4 and 5 present three exemplary embodiments of a cover screw incorporating a magnet in order to provide diagnostic and other functions in addition to the function of protecting the implanted bone fixture during a healing phase. An exemplary embodiment of the present invention includes the combination of various features of these embodiments into a usable screw cover.

FIG. 3 depicts a cover screw 10. The cover screw 10 illustrated in FIG. 3 has a main body 60 and an apical outer screw thread 70 to cooperate with an inner bottom bore with an internal screw thread of the implant bone fixture when the two parts of the cover screw and bone fixture are connected to each other. As discussed above, embodiments of the cover screw detailed herein may be used to cover the internal screw threads of the bone fixture (e.g., inner threads 4B of FIG. 1A). Accordingly, cover screw 10 has a cap 40 to cover these parts of the bone fixture during the healing period after the bone fixture is inserted into the skull. The main body 60 with the apical outer screw thread 70 is depicted as a one-piece configuration in FIG. 3, integral with the cap 40, but in other embodiments it can be provided in two or more parts whereby the threaded main body 60 secures the cap 40 to the bone fixture. The cap 40 has an annular flange 80 with a planar bottom surface 50 which rests against a corresponding surface on the bone fixture during the healing phase, after the cover screw 10 has been screwed onto the bone fixture. The annular flange 80, together with the planar bottom surface 50, provide a tight seal so that little to no body fluids can enter into the inner bottom bore with the internal screw thread of the bone fixture. In an exemplary embodiment, the cap 40 may be provided with a handling portion 20 for a cooperating insertion tool. The handling portion 20 may be realized in form of an internal hex, a hex recess, a hex tubular configuration, a hook or a unigrip interface, etc.

The cap may be provided with a rotation lock to prevent undesirable rotation of the cap 40 relative to the implanted anchoring element. In an exemplary embodiment, the rotation lock may allow for a more efficient transmission of vibrations to the bone fixture without affecting seal and stability of the implant. The rotation lock may be provided in form of a hex recess that is adapted to correspond with an external hex-structure of the implanted anchoring element. In the embodiment according to FIG. 3, the rotation lock can be provided e.g. as an internal hex structure on an inner surface of the annular flange 80 so that it corresponds with an external hex structure on an implanted anchoring element as illustrated in FIG. 1A or 1B. In this case, the cap 40 and the threaded main body have to be provided in two pieces whereby threaded main body fixes the cap to the implant. Alternatively, the rotation lock is provided in form of a tri-lobular system wherein the abutment sleeve has an external locking part (tri-lobe, not shown) and the implant has a corresponding recess. In this case, the cap 40 and the threaded main body may be provided in one piece.

The cover screw 10 may be made of a biocompatible material and may include a metal, such as, for example, titanium. In an exemplary embodiment, the material is sufficiently stiff and provides a good coupling between the cover screw and the bone fixture.

According to the embodiment depicted FIG. 3, a small permanent magnet 30 is incorporated in the cap 40 to enable additional functions such as diagnostics of implant stability and the possibility of inducing ossification by means of, for example, vibrations. The “built-in” permanent magnet makes it possible to use diagnostic tools such as RFA probes or the like or induce ossification by means of vibrations during the healing phase. The permanent magnet 30 is rigidly fixed in the cap 40 of the cover screw 10 and can then be oscillated by a magnetic field of controlled frequency, thus oscillating the bone fixture to which the cover screw 10 is attached. Specifically, movement of the permanent magnet 30, and thus movement of the cover screw 10 is transmitted to the cover screw 10, thus causing the cover screw 10 to move, and the detected resonance frequency of the cover screw 10, when attached to the bone fixture, can be used as a measure of implant stability or the vibratory movements can be used to effect stimulation of the implant-bone interface. The patient can be followed up on a regular schedule, and measurements of implant stability can be recorded each time. With this tool, the surgeon will have more information to base a decision whether sufficient healing has taken place to safely load the bone fixture (e.g. when a stability plateau is reached).

Any small-sized magnet from the main groups of NdFeB, SmCo, or Ferrite can be used. Alnico magnets can also be used for this purpose. Also, in alternate embodiments (of the embodiment depicted in FIG. 3 and other embodiments detailed herein), a magnet per-se is not located in the cover screw, as long as there is a body made of ferromagnetic material located in the cover screw that will “move” (react) when exposed to a magnetic field.

In case that the magnet (or other ferromagnetic material) is not bio-compatible and/or contains toxic material, the magnet is hermetically sealed within the cover screw 10 so that tissue contact is prevented. In the embodiment according to FIG. 3, the permanent magnet 30 is incorporated within the cap 40 of the cover screw 10. In order to achieve a hermetical seal, the permanent magnet 30 may be inserted into a blind hole within the cap 40 of the cover screw 10, the blind hole extending from an end face of the cap 40 in a direction to the main body 60 of the cover screw 10. After the permanent magnet 30 is inserted in the blind hole an opening of the blind hole is sealed with a biocompatible material. The material for sealing the blind hole may be the same as for the cover screw 10 and may be a metal, for example titanium. The opening of the blind hole may be sealed by a lock that is fixed in the cap by any one of press fitting, gluing, welding and screwing, so that the magnet is fixed in the blind hole free of clearance, in order to allow an efficient transmission of forces from the magnet to the implanted bone fixture.

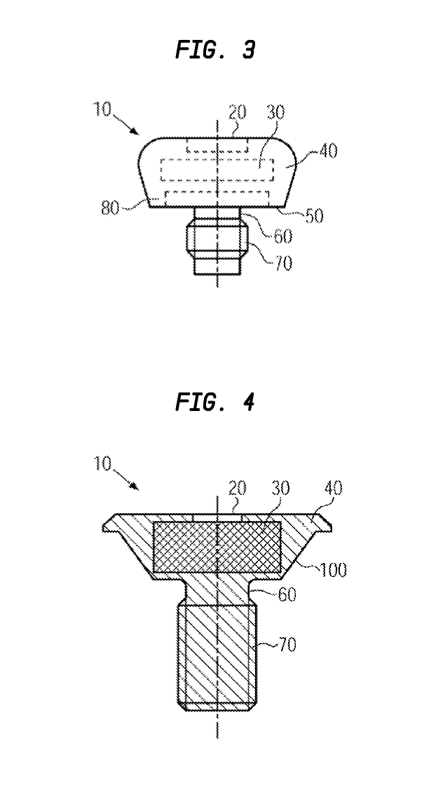

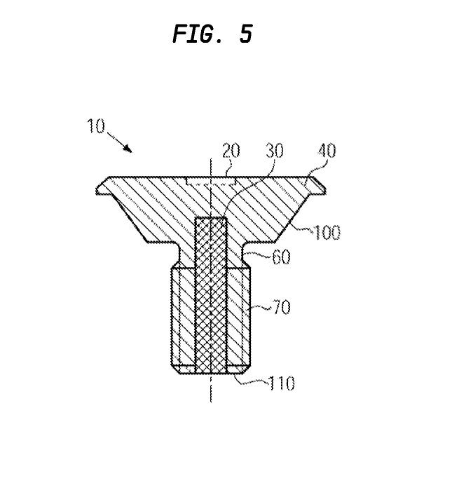

It is noted that while the embodiments of FIG. 3 (and FIGS. 4 and 5) have been disclosed as being a cover screw, other embodiments may be practiced where the cover clips onto or snaps onto the bone fixture. Any mechanical fastening system, device or method that will permit the present invention to be practiced (e.g., the transmission of vibration/movement of the magnet in the cover to the bone fixture, the transmission of force applied to the magnet in the cover to the bone fixture, etc.) may be used in some embodiments of the present invention.

FIG. 4 illustrates another exemplary embodiment of the cover screw 10. In FIG. 4 those features that are identically with features in FIG. 3 are designated with the same reference numerals. In FIG. 4 the cover screw cap 40 has an outer, tapered side wall 100 to create a good connecting fit with a corresponding tapered inner side wall of the implant bone fixture, forming a seat for the cover screw. Such a fit between conical shaped surfaces provides an axially well defined fit when the two parts are assembled and the risk for micro-leakage during the healing phase is reduced. Moreover, magnetic forces can be transmitted more efficiently to the implanted bone fixture (anchoring element).

The tapered sidewall 100 can be obtained by a cap 40 that has one of a pyramidal shape and a cone shape whereby the base of the cone and the pyramid is oriented in a direction facing away from the main body 60. The outer, tapered side wall 100 of the cone and the pyramid can be adapted to form a tight seal with a corresponding edge structure of the implanted anchoring element so that a tight seal can be formed between the edge structure of the implanted anchoring element and the cover screw.

Cap 40 and threaded main body can again be provided as separate parts and the cap can be provided with a rotation lock as pointed out in connection with the embodiment illustrated in FIG. 3. In case of a pyramidal shape of the cap 40, the cap 40 automatically provides a rotation lock function.

Also in the embodiment illustrated in FIG. 4 a permanent magnet 30 is incorporated in the cap 40 to enable measurement and stimulation. The magnet (or other ferromagnetic material) may be incorporated and sealed analogously to the embodiment described above.

FIG. 5 depicts a third exemplary embodiment of cover screw 10. In FIG. 5 those features that are the same or similar to the features in FIG. 4 are designated with the same reference numerals. FIG. 5 illustrates another location of the permanent magnet 30 (or other ferromagnetic material) within the cover screw 10.

In FIG. 5 the magnet is incorporated within the body 60 of the cover screw 10. According to this embodiment, the permanent magnet 30 can be inserted into a blind hole within the body 60 of the cover screw 10, extending from an end face 110 of the body 60 in a direction to the cap 40 of the cover screw 10. The permanent magnet 30 may be fixed in the body 60 by any one of press fitting, gluing, and welding. The permanent magnet 30 may also be provided with a thread so that the magnet 30 can be screwed into the blind hole in the body 60 that may be also provided with a corresponding thread.

In an exemplary embodiment, the blind hole in the body 60 need not be sealed, because the opening of the blind hole is already protected from body fluids through the cap 40 of the cover screw 10.

As already mentioned before, the features exemplified in the embodiments can be freely combined, such as, for example, to achieve some or all of the features mentioned herein. In an exemplary embodiment, some or all of the features in FIGS. 3, 4 and 5 can be combined, as possible by the skilled artisan. More particularly, the cover screw according to FIG. 3 can be provided with a tapered side wall 100 and a permanent magnet 30 inserted in the main body 60. In an exemplary embodiment, the magnet (or other ferromagnetic material) may be used for any type of measurement associated with the skull and implant stability or skull stimulation to enhance the stability of a bone implant.

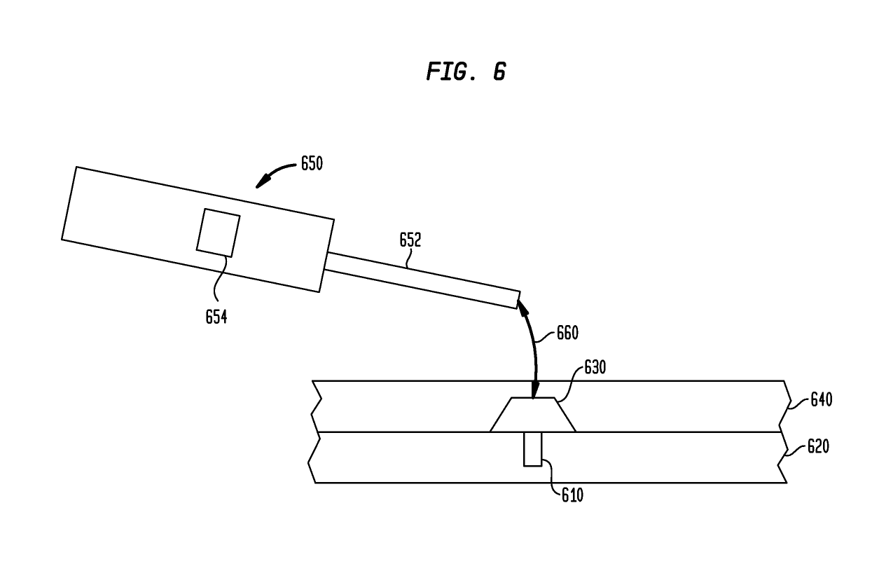

An exemplary embodiment of the present invention includes a method of diagnosing the extent of healing of the skull subsequent the installation of the bone fixture, and an apparatus for practicing such a method. The method utilizes and the apparatus functions with the cover as described herein and variations thereof Particularly, the present invention may be used to evaluate the state of the osseointegration process of the bone fixture with the skull. In an exemplary embodiment, referring to the functional schematic of FIG. 6, vibrations may be applied to the bone fixture 610 implanted in the skull 620 via the cover 630, and an evaluation of the stability of the bone fixture based on, for example, the resonant frequency of the cover-bone fixture assembly 635 (i.e., the cover 630 attached to the bone fixture 610) is identified. It is noted that the bone fixture 610 and the cover 630 may correspond to any of the bone fixtures and covers described herein. The principle of operation of this method is that the resonant frequency of the cover-bone fixture assembly 635 will change as the healing process (osseointegration process) progresses, as will now be described in greater detail.

Accordingly, in an exemplary embodiment of the present invention, there is a method (and an apparatus configured for use in executing the method) comprising comparing the resonant frequency of the cover-bone fixture assembly 635 against known resonant frequencies to determine how well the skull has healed/to determine the state of osseointegration of the bone fixture with the skull. These known resonant frequencies may correspond to the resonant frequency of the cover 630, and may correspond to various states of healing/osseointegration, developed empirically and/or analytically, of the cover-bone fixture assembly 635.

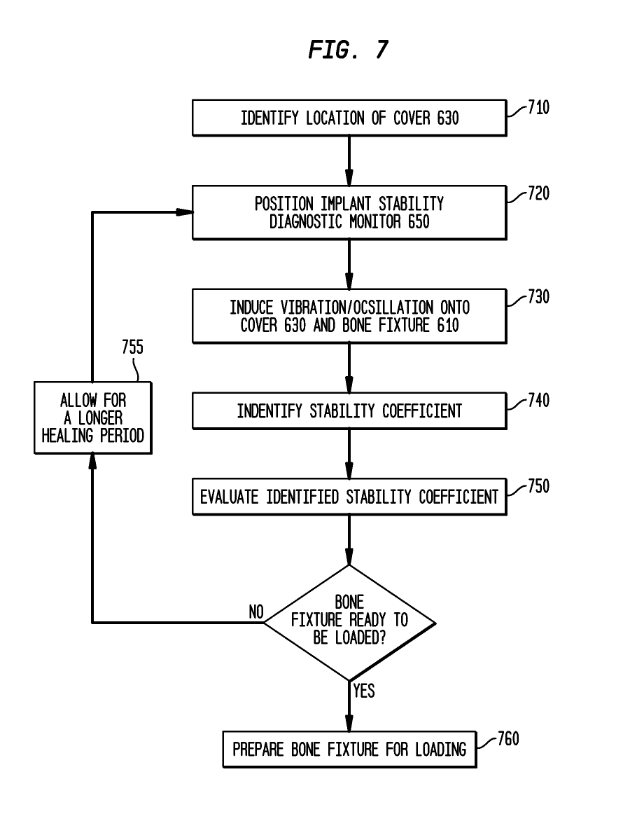

More specifically, referring to FIG. 6 and the flowchart of FIG. 7, the location of the cover 630 vis-à-vis the head of a recipient is first identified at step 710. This step may be performed after the cover 630 is installed in the bone fixture and the opening through the skin 640 is closed (e.g., the skin is “sutured” so that skin covers the cover 630) or, in some embodiments where the diagnostic method is practiced proximate the time of implantation of the bone fixture 610, prior to closing the opening through the skin 640.

After identifying the location of the cover 630, at step 720, an implant stability diagnostic monitor 650 with a probe sensor 652 is positioned such that at least a portion of probe sensor 652 is interposed in a magnetic field 660 between and encompassing the cover 630 (more particularly, the ferromagnetic material of the cover 630) and the probe sensor 652.

The magnetic field 660 is sufficiently strong enough to penetrate the skin 640 covering the cover 630. In an exemplary embodiment, the implant stability diagnostic monitor 650 may generate the magnetic field 660, and/or the cover 630 may generate the magnetic field (in the case that the cover 630 includes a magnetic), depending on the configuration of the cover 630 as would be understood by one of skill in the magnetic arts. At step 730, when the probe sensor 652 and the cover 630 are the magnetic field 660, a vibration/oscillation is induced into the cover 630, and thus the bone fixture 610.

At step 740, the resonant frequency of the cover-bone fixture assembly 635 is identified, and, based on this identification, a stability coefficient (also referred to as stability quotient) is identified. The stability coefficient may correspond to a linear mapping of the resonance frequency of the cover 630 and/or the bone fixture assembly 635. The stability coefficient is a function of the stiffness of the bone fixture 610 in the surrounding bone. The resonant frequency is correlated to the stiffness. As the stability of the cover-bone fixture assembly 635 improves over time due to osseointegration, the resonant frequency will change, and thus the stability coefficient will also change.

In an exemplary embodiment, the resonant frequency and the stability coefficient are automatically identified by implant stability diagnostic monitor 650, and the resonant frequency and/or the stability coefficient are displayed on indicator screen 654.

The stability coefficient is identified by correlating the identified resonant frequency value with values previously stored in the implant stability diagnostic monitor 650 that correspond to stability coefficients on a scale of, for example, 1 to 100.

At step 750, an evaluation is made of the identified stability coefficient and/or the identified resonant frequency of the cover-bone fixture assembly 635. In an exemplary embodiment, these stability coefficients previously have been empirically and/or analytically evaluated to determine or otherwise estimate the extent to which osseointegration of the cover-bone fixture assembly 635 has progressed. Specifically, the identified stability coefficient and/or the identified resonant frequency is compared to a value or a range of values that are known or otherwise believed to indicate that the bone fixture 610 is ready to be loaded with a bone conduction device. If, at step 750, the identified stability coefficient and/or the identified resonant frequency corresponds to a value or otherwise falls within the range of values that are known or otherwise believed to indicate that the bone fixture 610 is ready to be loaded, the method proceeds to step 760.

At step 760, at least one action is taken to prepare the bone fixture 610 for loading. Such action(s) may include indicating that the bone fixture 610 is ready for loading, whereby the indication is used or otherwise relied on by a doctor or skilled technician to load the bone fixture 610. Such actions may also include removing the cover 630 and attaching a bone conduction device to the bone fixture 610 and/or attaching an abutment to the bone fixture 610 followed by attachment of a bone conduction device to the abutment. It is noted that in an exemplary embodiment, steps 720, 730 and 740 may be repeated during the same session to identify two or more stability coefficients. In an exemplary embodiment, the probe sensor 652 is repositioned at step 720 in a direction perpendicular or about perpendicular to the direction where the probe sensor 652 was previously positioned when the first stability coefficient 740 was identified. In this manner, an accounting may be made of more stable and less stable directions of the bone fixture 610. The lower coefficient of the two or more coefficients identified may be displayed or otherwise relied upon to determine whether the bone fixture 610 is ready for loading.

If, at step 750, the identified stability coefficient (or the lower of the two or more identified stability coefficients) and/or the identified resonant frequency does not correspond to a value or otherwise falls outside the range of values that are known or otherwise believed to indicate that the bone fixture 610 is ready to be loaded, the method proceeds to step 755. At step 755, a longer healing period is provide. After this longer healing period has elapsed (e.g., a week, two weeks, three weeks, one month, etc. after step 750) and the osseointegration process has been given more time to progress, the method proceeds back to step 720.

Because the resonant frequency may be evaluated to determine the state of healing, the bone fixture may be safely loaded at an earlier date, relative to the initial insertion of the bone fixture in the skull, than would otherwise be the case, because it will not be as necessary to build in a factor of safety wait-time based on, for example, a worst case or even an average case scenario of how long the osseointegration process will take to achieve a level of integration that makes it safe to load the bone fixture.

In an exemplary embodiment, any device, method or system that may permit the resonant frequency and/or the stability coefficient to be determined to evaluate the progress of the osseointegration process may be used to practice some embodiments of the present invention.

The method just described may be used to identify the end of the natural dip in the stability of the bone fixture after implant, where the bone fixture becomes less stable than when originally implanted. That is, typically, a bone fixture is more stable immediately after implantation than shortly after implantation. The stability falls off and remains low for about two weeks or so after implantation, and then increases again (forming a dip if stability is charted against time). It is useful to know when this dip ends, at least with respect to practicing a method of enhancing the osseointegration process, as will be detailed below.

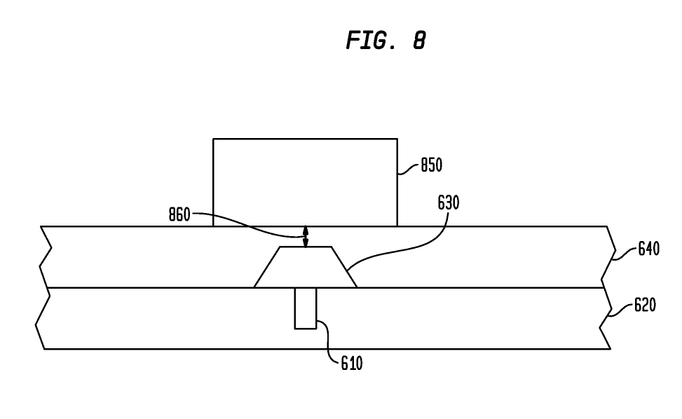

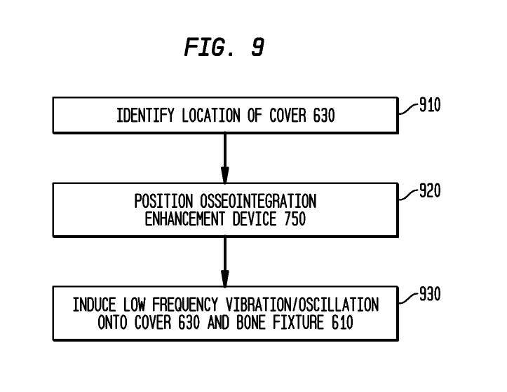

Referring to FIGS. 8 and 9, an exemplary embodiment of the present invention includes a method of and an apparatus used to speed osseointegration of the skull 620 with the bone fixture 610. In an exemplary embodiment, low frequency vibrations (e.g., at or below 100 Hz) may be applied to the bone fixture 630 via the cover 630 to speed up the osseointegration process.

Specifically, at step 910, the location of the cover 630 is identified. Step 910 corresponds to step 710 detailed above, and may be practiced while skin 640 covers the cover 630 or while skin 630 is open (i.e., prior to closing of skin 630 during the surgical procedure).

At step 920, osseointegration enhancement device 850 is positioned proximate to the cover 630 as shown in FIG. 8, although in other embodiments, such as in the case where the skin 630 is open, other placements of the osseointegration enhancement device 750 may be practiced. Positioning of the osseointegration enhancement device 850 is such that the device, along with cover 630, are interposed in a magnetic field 860 between the cover 630 and the osseointegration enhancement device 850.

It is noted that in an exemplary embodiment, the osseointegration enhancement device 850 includes a strap or harness or headband that extends about the head, or other holding device (such as a modified hat or helmet) to retain the osseointegration enhancement device 850 sufficiently proximate the cover 630 to practice the method.

The magnetic field 660 is sufficiently strong enough to penetrate the skin 640 covering the cover 630. In an exemplary embodiment, the osseointegration enhancement device 850 may create the magnetic field 660, and/or the cover 630 may create the magnetic field, depending on, for example, the configuration of the cover 630 as would be understood by one of skill in the magnetic arts.

At step 930, as a result of the placement of the osseointegration enhancement device 850 and the cover 630 in the magnetic field 860, and upon any activation, if necessary, of the osseointegration enhancement device 850, a vibration/oscillation is induced into the cover 630, and thus the bone fixture 610. This vibration/oscillation of the bone fixture 610 may correspond to an up-and-down motion (i.e., parallel to the longitudinal axis of the bone fixture 610) and/or a rocking motion (i.e., movement that tilts the longitudinal axis from side to side in one or more planes).

In an exemplary embodiment, when the osseointegration enhancement device 850 and the cover 630 (more particularly, the ferromagnetic material of the cover 630) are in the magnetic field 860, a low frequency vibration/oscillation is induced onto the cover 630, and thus the bone fixture 610. This vibration/oscillation may be induced for ten, twenty, thirty or forty minutes or so or more during a given treatment, and this treatment may be administered on, for example, about a daily or weekly or two week or three week or monthly basis, etc. In an exemplary embodiment, the first such treatment may be performed about two weeks after the bone fixture 610 is implanted into the skull 620. (This avoids the natural dip in the stability of the bone fixture after implant, where the bone fixture becomes less stable than when originally implanted.) In the exemplary embodiment, the vibration/oscillation speeds up the osseointegration process, thus permitting the bone fixture 610 to be safely loaded at an earlier date, relative to the initial insertion of the bone fixture 630 into the skull 620, than would otherwise be the case. In an exemplary embodiment, the method of evaluating the progress of the osseointegration process (e.g., the method represented by the flowchart of FIG. 7) may be combined or otherwise practiced with the method of enhancing/speeding up the osseointegration process (e.g., the method represented by the flowchart of FIG. 9).

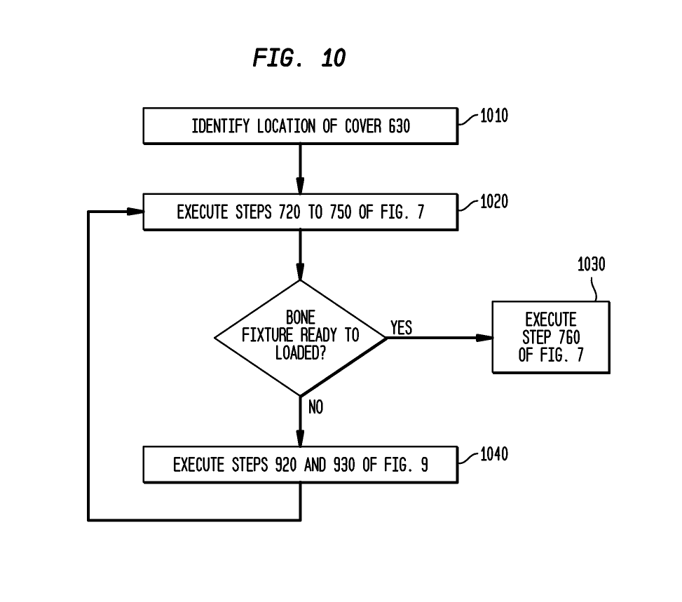

By way of example, steps 710 to steps 750 of FIG. 7 may be executed, and, upon a determination that the bone fixture 610 is not ready to be loaded, at least steps 920 and 930 may be executed. More particularly, referring to FIG. 10, at step 1010, the location of the cover 630 is identified. Step 1010 corresponds to step 710 detailed above with respect to FIG. 7. At step 1020, steps 720 to 750 of FIG. 7 are executed. Upon a determination at step 750 that the bone fixture 610 is ready to be loaded, the method proceeds to step 1030, where step 760 of FIG. 7 is executed. Upon a determination at step 750 that the bone fixture 610 is not ready to be loaded, the method proceeds to step 1040, where steps 920 and 930 of FIG. 9 are executed. The method then proceeds back to step 1020 in a manner analogous to/the same as the proceeding back to step 720 from step 750 of FIG. 7.

In an exemplary embodiment, the features of the osseointegration enhancement device 850 may be combined with the features of the implant stability diagnostic monitor 650 detailed above. That is, an exemplary embodiment includes a combination osseointegration enhancement device and implant stability diagnostic monitor combined into one device. Such a combination device may be configured for use in executing the method represented in FIG. 10.

In an exemplary embodiment, the combination device and/or the implant stability diagnostic monitor 650 may be configured to record in an electronic format electronic data indicative of stability coefficients determined over a period of time, which may be downloaded from the devices and saved in a database and/or evaluated.

Further along these lines, the combination device and/or implant stability diagnostic monitor 650 or the osseointegration enhancement device 850 might be devices issued to the recipient of a cover for a bone fixture as disclosed herein and taken home. In an exemplary scenario, the device(s) is taken home by a recipient, and is periodically used to enhance the osseointegration process and/or obtain a stability coefficient (depending on the device taken home by the recipient). While at home, the recipient uses the applicable device(s) to practice the method represented in FIG. 10, at least with respect to any or all of steps 1020, 1030 and/or 1040 (where the device(s) taken home may include a harness that automatically positions the device/monitor proximate the cover 630 due to the geometric configuration of the harness), and, optionally, step 1010. This permits the number of visits to a doctor or other trained personnel to monitor the osseointegration process and/or to enhance the osseointegration process to be reduced.

The recipient using the device(s) at home may periodically report the obtained stability coefficient to a central location (via phone, computer, mail, the act of periodically brining in the combination device and/or the implant stability diagnostic monitor 650 into the central location whereby electronic data indicative of stability coefficients determined over a period of time may be downloaded, etc.) so that the stability coefficient can be evaluated.

The method of FIG. 10 may be practiced by the recipient (optionally, with obtained stability coefficients being periodically reported to the central location), until a determination is made that the bone fixture 610 is ready to be loaded. This determination may be made automatically by the device and/or at the remote location (automatically or by trained personnel). At the completion of the method represented by FIG. 10, the recipient may return the device(s), as applicable, at which time the combination device may be sterilized or otherwise cleaned so that it can be issued to another recipient at a subsequent time.

The combination device just detailed, and the implant stability diagnostic monitor 650 described above, may be configured to communicate, independently and/or by way of a separate interface, with a remote database and/or a remote computer, such that diagnostic information (e.g., the stability coefficient) may be automatically communicated to that remote database or computer. At the remote site, the diagnostic information may be evaluated and/or simply stored for later evaluation.

An exemplary embodiment relies on vibrating the bone fixture. In an exemplary embodiment, the stability of the bone fixture is enhanced by inducing implant micro-motions via a permanent magnet coupled to the bone fixture which is vibrated using a cyclic magnetic force to enhance growth and apposition of the surrounding bone.

In an exemplary embodiment of the present invention, there is a cover screw that is adapted to function as part of a diagnostics tool to diagnose the stability of the implanted bone fixture. This is in addition to the function of the bone screw of covering the connection and inner threads of the implanted bone fixture. This exemplary embodiment may further include a cover screw that functions to induce or otherwise improve ossification through the use of vibrations imparted on the bone fixture without a mechanical component penetrating the skin.

In an exemplary embodiment, these functions may be achieved by integrating a magnet into the cover screw to provide a cover screw adapted for use in a diagnostic system and a stimulation system. In an exemplary embodiment, the cover screw, including the magnet, is attached to the bone fixture during the first stage of the two stage procedure (the stage where the bone fixture is implanted unto the skull), and is utilized during the subsequent healing phase of a two stage procedure.

An exemplary embodiment of the present invention, there is a cover screw that is adapted to cooperate with an anchoring element, such as the bone fixture 4 detailed above, implanted into the skull of a recipient so that an external vibrator may be attached to the anchoring element. The cover screw is adapted to be connected to the implanted anchoring element (e.g., the bone fixture) during the healing phase after implantation of the anchoring element, and used for diagnostic purposes and/or to enhance the healing process.

In an exemplary embodiment, the cover screw according to the present invention is adapted to cover a connection portion and an interior of the implanted anchoring element during the healing phase. In addition, the cover screw may be provided with a magnet to enable additional functions such as measurement of implant stability and to permit stimulation to be provided to the bone proximate the bone fixture by inducing vibrations into the bone fixture via a magnetic field applied to the magnet.

In an embodiment the magnet may be hermetically sealed within the cover screw so that tissue and/or body fluid contact with the magnet is prevented. In another embodiment, the cover screw may be made of a biocompatible material. In another embodiment, the cover screw may be made of a metal, for example of titanium. In another embodiment, the bone fixture may be made of a metal, for example, titanium. In a further embodiment, the magnet may be made of NdFeB, SmCo, Ferrite or Alnico magnets.

In an embodiment the cover screw may comprise a main body, an apical outer screw thread adapted to cooperate with an inner bottom bore with an internal screw thread of the implanted anchoring element when the two parts cover screw and anchoring element are connected to each other, and a cap to cover the connection and interior of the anchoring element during the healing phase.

In an embodiment thereof, the cap may have an annular flange with a planar bottom surface which is adapted to rest against a corresponding surface on the implanted anchoring element during the healing phase.

In another embodiment thereof the cap may have one of a pyramidal shape and a cone shape with the base of the cone and the pyramid being oriented in a direction facing away from the main body, wherein an outer, tapered side wall of the cone and the pyramid is adapted to form a tight seal with a corresponding edge structure of the anchoring element so that a tight seal can be formed between the edge structure of the implanted anchoring element and the cover screw. In another embodiment, the cap may be provided with a rotation lock to prevent rotation of the cap relative to the implanted anchoring element. The rotation lock may be provided in form of a hex recess or other shape that is adapted to correspond with an external hex-structure of the implanted anchoring element. Alternatively, the rotation lock can be provided in form of a tri-lobular system, etc.

In one embodiment, the magnet may be incorporated within the body of the cover screw, whereby the magnet is inserted into a blind hole within the body of the cover screw, extending from an end face of the body in a direction to the cap of the cover screw. The magnet may be fixed in the body by any one of press fitting, gluing, welding and screwing.

In another embodiment, the magnet may be incorporated within the cap of the cover screw, whereby the magnet may be inserted into a blind hole within the cap of the cover screw, extending from an end face of the cap in a direction to the body of the cover screw, wherein an opening of the blind hole is sealed with a biocompatible material. The material for sealing the blind hole may be a metal, for example titanium. The opening of the blind hole may be sealed by a lock that is fixed in the cap by any one of press fitting, gluing, welding and screwing, so that the magnet is fixed in the blind hole free of clearance.

According to another embodiment of the present invention, there is provided a cover screw adapted to cooperate with an anchoring element, such as the bone fixture 4 detailed above, wherein said cover screw is adapted to be connected to the implanted anchoring element during a healing phase after implantation of the anchoring element. In this exemplary embodiment, the cover screw is adapted to cover a connection portion and an interior of the implanted anchoring element during the healing phase, wherein the cover screw is provided with a magnet to enable additional functions such as measurement of implanted anchoring element (bone fixture 4) stability and stimulation of the implant-bone interface. In this exemplary embodiment, the cover screw comprises a main body, an apical outer screw thread adapted to cooperate with an inner bottom bore with an internal screw thread of the implanted anchoring element when the two parts cover screw and anchoring element are connected to each other, and a cap to cover the connection and interior of the anchoring element during the healing phase, and wherein the cap has an annular flange with a planar bottom surface which is adapted to rest against a corresponding surface on the implanted anchoring element during the healing phase.

In an exemplary embodiment, the cap may have one of a pyramidal shape and a cone shape with the base of the cone and the pyramid being oriented in a direction facing away from the main body, wherein an outer, tapered side wall of the cone and the pyramid is adapted to form a tight seal with a corresponding edge structure of the anchoring element so that a tight seal can be formed between the edge structure of the implanted anchoring element and the cover screw.

According to another exemplary embodiment of the present invention, there is provided a cover screw adapted to cooperate with an anchoring element implanted into the skull bone. The cover screw is adapted to be connected to the implanted anchoring element during a healing phase after implantation of the anchoring element, wherein said cover screw is adapted to cover a connection portion and an interior of the implanted anchoring element during said healing phase. In this exemplary embodiment, the cover screw is provided with a magnet to enable additional functions such as measurement of implant stability and stimulation of the implant-bone interface, wherein the cover screw comprises a main body, an apical outer screw thread adapted to cooperate with an inner bottom bore with an internal screw thread of the implanted anchoring element when the two parts cover screw and anchoring element are connected to each other, and a cap to cover the connection and interior of the anchoring element during the healing phase. In this exemplary embodiment, the cap has one of a pyramidal shape and a cone shape with the base of the cone and the pyramid being oriented in a direction facing away from the main body, wherein an outer, tapered side wall of the cone and the pyramid is adapted to form a tight seal with a corresponding edge structure of the anchoring element so that a tight seal can be formed between the edge structure of the implanted anchoring element and the cover screw.

In another exemplary embodiment, the cap may have an annular flange with a planar bottom surface which is adapted to rest against a corresponding surface on the implanted anchoring element during the healing phase.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A cover for a bone fixture, including a recess to receive an abutment, the cover comprising:
a fixation device sized and dimensioned to rigidly connect the cover to the bone fixture; and
a ferromagnetic material reactive to a magnetic field,
wherein the cover is dimensioned to cover at least the recess of the bone fixture, and
wherein the fixation device is configured to transmit vibrations induced in the cover via the magnetic field into the bone fixture.

2. A cover according to claim 1, wherein the cover is adapted to enable a measurement of stability of the bone fixture and to enable stimulation of osseointegration of the bone fixture with a skull.

3. A cover according to claim 1, wherein the ferromagnetic material is hermetically sealed within the cover.

4. A cover according to claim 3, wherein the cover is made of titanium.

5. A cover according to claim 1, wherein the ferromagnetic material is a magnet.

6. A cover according to claim 1, wherein the cover is a cover screw that comprises:
a main body;
an apical outer screw thread adapted to cooperate with an internal screw thread of the bone fixture when the cover screw and the bone fixture are connected to each other; and
a cap sized and dimensioned to cover the recess and at least a portion of the bone fixture surrounding the recess after the cover is attached to the bone fixture.

7. A cover according to claim 6, wherein the cap has an annular flange with a planar bottom surface which is adapted to rest against a corresponding surface on the bone fixture after the cover is attached to the bone fixture.

8. A cover according to claim 6, wherein:
the cap has one of a pyramidal shape and a cone shape with the base of the cap being oriented in a direction facing away from the main body;
an outer, tapered side wall of the cap is sized and dimensioned to form a seal with a corresponding edge structure of the bone fixture so that a seal is formed between the edge structure of the bone fixture and the cover.

9. A cover according to claim 6, wherein the cap is provided with a rotation lock to at least one of limit or prevent rotation of the cap relative to the bone fixture.

10. A cover according to claim 9, wherein the rotation lock is provided in the form of a hex recess that is sized and dimensioned to correspond with an external hex-structure of the bone fixture.

11. A cover according to claim 9, wherein the rotation lock is a tri-lobular system.

12. A cover according to claim 11, wherein the ferromagnetic material is fixed in the cover by at least one of a press fit, adhesive, a weld or a screw.

13. A cover according to claim 6, wherein the ferromagnetic material is incorporated within the cap of the cover.

14. A cover according to claim 13, wherein the cover includes a blind hole, ferromagnetic material is located in the blind hole within the cap of the cover, the blind hole extending from an end face of the cap in a direction to the main body of the cover, and an opening of the blind hole is sealed with a biocompatible material.

15. A cover according to claim 14, wherein the material sealing the blind hole is titanium.

16. A cover according to claim 15, wherein the opening of the blind hole is sealed by a lock that is fixed in the cap by at least one of a press fit, an adhesive, a weld or a screw, so that the ferromagnetic material is fixed in the blind hole free of clearance between the ferromagnetic material and the blind hole.

17. A method of monitoring a osseointegration progress the method comprising:
inducing vibation of a ferromagnetic material of a cap connected to an implanted bone fixture via a transcutaneous magnetic field; and
identifying a vibrational characteristic of the implanted bone fixture.

18. The method of claim 17, wherein the vibrational characteristic of the implanted bone fixture is indicative of a state of osseointegration of the implanted bone fixture with a skull, the method further comprising:
evaluating the identified vibrational characteristic of the implanted bone fixture and determining whether to load the bone fixture with a bone conduction device based on the evaluation of the identified vibrational characteristic of the implanted bone fixture.

19. The method of claim 17, wherein the vibrational characteristic of the implanted bone fixture is a resonant frequency of the implanted bone fixture.

20. The method of claim 17, further comprising:
upon determining whether to load the bone fixture with a bone conduction device based on the evaluation, preparing the bone fixture for loading of a bone conduction device.

21. A method of enhancing osseointegration of an implanted bone fixture, the method comprimising:
transcutaneously inducing a low frequency vibration of the implanted bone fixture.

22. The method of claim 21, wherein the low frequency vibration is induced into the implanted bone fixture via a transcutaneous magnetic field encompassing a ferromagnetic material located in a cap connected to the implanted bone fixture.

23. The method of claim 21, wherein the low frequency vibration is about 100 Hz or less.

24. The method of claim 21, wherein the low frequency vibration is induced for at least 10 minutes at least once a week at least four times.

25. The method of claim 22, further comprising positioning an osseointegration enhancement device such that the magnetic field encompasses at least a portion of the osseointegration enhancement device and driving the low frequency vibrations with the osseointegration enhancement device.

26. A cover according to claim 1, wherein:
the bone fixture being a part of a bone conduction hearing prosthesis.

27. A cover according to claim 1, wherein:
the fixation device is configured to be covered by a layer of skin.

28. The method of claim 17, wherein:
the osseointegration progress is the osseointegration progress of a recipient's skull after the bone fixture is implanted in the skull.

29. The method of claim 17, wherein:
the bone fixture is part of a bone conduction implant configured to transmit vibrations indicative of sound to a recipient's skull to enhance hearing.

30. The method of claim 17, wherein:
the ferromagnetic material and the implanted bone fixture are located under the skin of the recipient.

31. The method of claim 21, wherein:
the bone fixture is part of a bone conduction implant configured to transmit vibrations indicative of sound to a recipient's skull to enhance hearing.

32. The method of claim 21, wherein:
the implanted bone fixture is implanted in a recipient's skull; and
the action of transcutaneously inducing a low frequency vibration of the implanted bone fixture enhances osseointegration of the implanted bone fixture with the skull relative to osseointegration of the implanted bone fixture with the skull in the absence of the induced low frequency vibration.
